(19) United States
(12) Patent Application Publication
(10) Pub. No.: US 2017/0255821 A1
(43) Pub. Date: Sep. 7, 2017

(54) GESTURE RECOGNITION SYSTEM AND RELATED METHOD

(71) Applicant: National Taiwan University, Taipei (TW)

(72) Inventors: Bing-Yu Chen, Taipei (TW); Li-Wei Chan, Taipei (TW); Yi-Ling Chen, Taipei (TW); Chi-Hao Hsieh, Taipei (TW); Rong-Hao Liang, Taipei (TW)

(21) Appl. No.: 15/059,028

(22) Filed: Mar. 2, 2016

(51) Int. Cl. G06K 9/00; G06T 7/00; G06T 7/40; H04N 5/232

(52) U.S. Cl. CPC G06K 9/00335; H04N 5/23238; G06T 7/0051; G06T 7/408

(57) ABSTRACT

A recognition system and a recognition method are provided. The recognition system includes a camera having a wide angle-of-view, a transmitter electrically connected to the camera, and a processor communicating with the transmitter. The camera is mounted on a body or a finger of a user, and captures one or more raw images of the limbs or hands. The transmitter transmits the one or more raw images of the limbs or hands to the processor. The processor transforms the one or more raw images of the limbs or hands into a corresponding gesture image, builds a recognition module according to a plurality of gesture images of the limbs or hands, and recognizes one or more new raw images of the limbs or hands captured by the camera with the recognition module so as to recognize a bodily gesture or a hand gesture.

### BACKGROUND

1. Technical Field

This disclosure relates to recognition systems and related methods, and, in particularly, to a gesture recognition system and a related method that recognizes a bodily gesture or a hand-gesture of a user.

2. Description of Related Art

Currently, motion recognition of the user is generally implemented by an external camera or a plurality of motion sensors distributed across the body of the user.

The external camera may be a depth-sensing camera and enabled reliable body tracking. However, the external camera usually has a limited working distance owing to the angle-of-view of the camera.

On the other hand, although the motion sensors may be wearable devices that are put on arms, legs, shoulders, fingers and so on, wearing these motion sensors is commonly inconvenient.

Therefore, it is an urgent issue in the art to provide a recognition system and a recognition method that can recognize a bodily gesture or a hand-gesture of a user so as to improve the above defects.

### SUMMARY

The present disclosure provides a gesture recognition system, comprising: a camera configured to capture a user to obtain one or more raw images, wherein the camera is mounted on the user and has a wide angle-of-view; a transmitter electrically connected to the camera to transmit the one or more raw images; and a processor configured to receive and process the one or more raw images, transform the processed one or more raw images into a corresponding gesture image, and build a recognition module according to a plurality of gesture images, such that the processor recognizes a gesture of the user through the recognition module when one or more new raw images are captured by the camera.

The present disclosure further provides a method for recognizing a gesture, comprising: mounting a camera having a wide angle-of-view on a central portion of a body of a user; capturing a sequence of raw images of a limb of the user by the camera; receiving and processing the sequence of raw images; transforming the sequence of raw images into a corresponding gesture image; building a recognition module according to a plurality of gesture images; and recognizing a bodily gesture of the limb of the user through the recognition module when a new sequence of raw images is captured by the camera.

The present disclosure also provides a method for recognizing a gesture, comprising: mounting a camera having a wide angle-of-view on a finger of a user; capturing a raw image of a hand of the user by the camera; receiving and processing the raw image; transforming the raw image into a corresponding gesture image; building a recognition module according to the gesture image; and recognizing a hand gesture of the user through the recognition module when a new raw image is obtained by the camera.

### BRIEF DESCRIPTION OF DRAWINGS

The disclosure can be more fully understood by reading the following detailed descriptions of the embodiments, with reference made to the accompanying drawings, wherein:

FIG. 1 is a functional block diagram of a gesture recognition system of an embodiment according to the present disclosure;

FIG. 2 shows a single-piece wearable device worn as a pendant or a badge according to the present disclosure;

FIG. 3 is a flow chart of a method for recognizing a bodily gesture of a user of an embodiment according to the present disclosure;

FIGS. 4a(1)-4a(5) and 4b(1)-4b(5) show that a user moves part of his body according to the present disclosure;

FIGS. 5a-5c illustrate raw images being processed to extract foreground objects according to the present disclosure;

FIGS. 6a and 6b illustrate gesture image generation according to the present disclosure;

FIGS. 7a and 7b show twenty bodily gestures and twenty gesture images corresponding to the bodily gestures, respectively, according to the present disclosure;

FIG. 8 is a flow chart of a method for recognizing a hand-gesture of a user of an embodiment according to the present disclosure;

FIG. 9a shows a raw image of a hand obtained by the camera according to the present disclosure;

FIG. 9b shows a processed image where the hand is recognized as the foreground object and the background object is removed according to the present disclosure;

FIG. 9c represents a gesture image with the hand that is brighter and the background object that is darker according to the present disclosure; and

FIGS. 10a and 10b show seven hand gestures and seven gesture images corresponding to the seven hand gestures according to the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

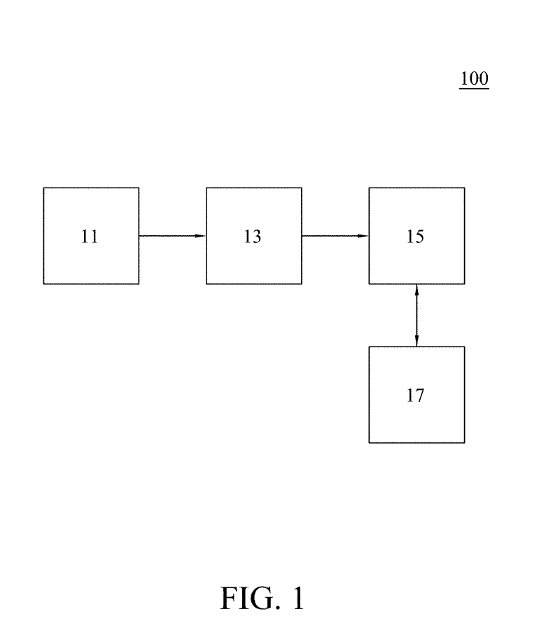

FIG. 1 is a functional block diagram of a gesture recognition system 100 of an embodiment according to the present disclosure. The gesture recognition system 100 comprises a camera 11, a transmitter 13, a processor 15 and a memory 17.

The camera 11 includes an image sensor and one or more lenses, and is configured to capture an image or a sequence of images of a user. The image sensor may be provided with a charge-coupled device (CCD) or a complementary metal-oxide-semiconductor (CMOS) type device that converts the received light intensities into corresponding electrical signals. The one or more lenses may have a fish-eye lens or a lenses-assembly with a wide angle-of-view. In an embodiment, the camera 11 is equipped with a wide-angle lens and may have an angle-of-view more than 180 degree, such as 185 degree or 235 degree.

In an embodiment, the camera 11 further includes an emitter attached around the one or more lenses, such that the camera emits light to the user and receive the light reflected from the user to obtain depth-like information related to the images. Accordingly, the processor 15 can distinguish the user from the background based on the depth-like information. The emitter may be implemented by infrared LEDs to provide uniform illumination, such that the user looks brighter than a background object. The camera 11 with the attached infrared LEDs can detect both visible and infrared light. To facilitate extracting the user from images, a filter is included in the camera 11 to block visible light and allow only infrared reflection from foreground objects, such as the body, to pass. Alternatively, the camera 11 may be a time-of-flight depth camera which can capture images with depth information.

The transmitter 13 is electrically connected to the camera 11 to transmit images to the processor 15. The transmitter 13 can also be mounted on the user or combined with the camera 11.

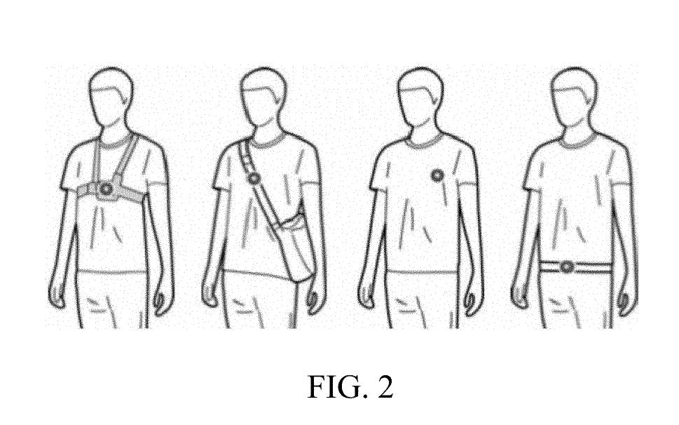

In an embodiment, the camera 11 is mounted on a central portion of the body of a user, for example, the camera 11 may be mounted on the chest. In an embodiment, the camera 11 and the transmitter 13 can be integrated into a single-piece wearable device. As shown in FIG. 2, the single-piece wearable device is worn as a pendant or a badge, fixed on a strap of a bag, or is worn as a buckle of a belt. In an embodiment, the camera has an angle-of-view of about 235 degree, such that the camera 11 is capable of capturing a sequence of raw images of limbs of the user from the first-person perspective.

The processor 15 is configured to receive and process one or more raw images from the transmitter 13. As such, a sequence of raw images can be processed and transformed into a corresponding gesture image that represents a bodily gesture or a hand gesture. In an embodiment, the processor 15 may employ a plurality of gesture images to build a recognition module stored in the memory 17. Accordingly, when a new raw image is captured by the camera 11, the processor 15 generates a corresponding new gesture image and recognizes a bodily gesture or a hand gesture with the recognition module according to the new gesture image. In an embodiment, the processor 15 and the memory 17 may be incorporated into a computer or a processing unit. The details will be described later.

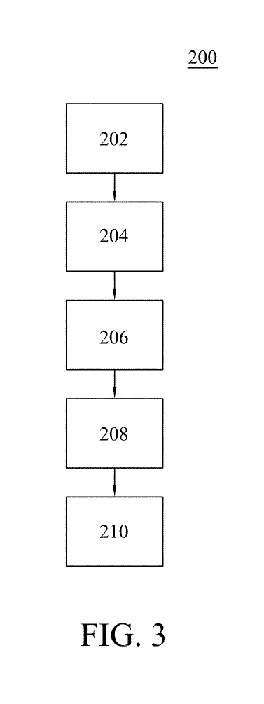

FIG. 3 is a flow chart of a method 200 for recognizing a bodily gesture of a user according to an embodiment of the present disclosure.

In step 202, a camera having a wide angle-of-view is mounted on a central portion of a body of a user. In an embodiment, the camera has an angle-of-view of more than 180 degrees, such as 235 degrees.

In step 204, the camera captures a sequence of raw images of at least one limb of the user. In an embodiment, the camera further obtains depth information related to the sequence of raw images.

In step 206, the processor receives and processes the sequence of raw images. The processed sequence of raw images distinguish the at least one limb of the user from a background object. For example, the at least one limb of the user is distinguished from the background object with or without the depth information and marked as foreground objects.

In step 208, the processor generates a gesture image according to the processed sequence of raw images. The gesture image has spatial and temporal information of the at least one limb of the user, such that the gesture image represents a bodily gesture. Subsequently, the processor builds a recognition module given a plurality of gesture images. For example, the recognition module is trained by a plurality of gesture images with corresponding known bodily gesture(s), such that the trained recognition module is capable of recognizing one or more bodily gestures. In an embodiment, the recognition module is stored in a memory.

In step 210, when the user performs a bodily gesture, the camera captures a new sequence of raw images of the limb(s) of the user. The processor transforms the new sequence of raw images into a corresponding new gesture image and recognizes the bodily gesture performed by the user through the recognition module according to the new gesture image.

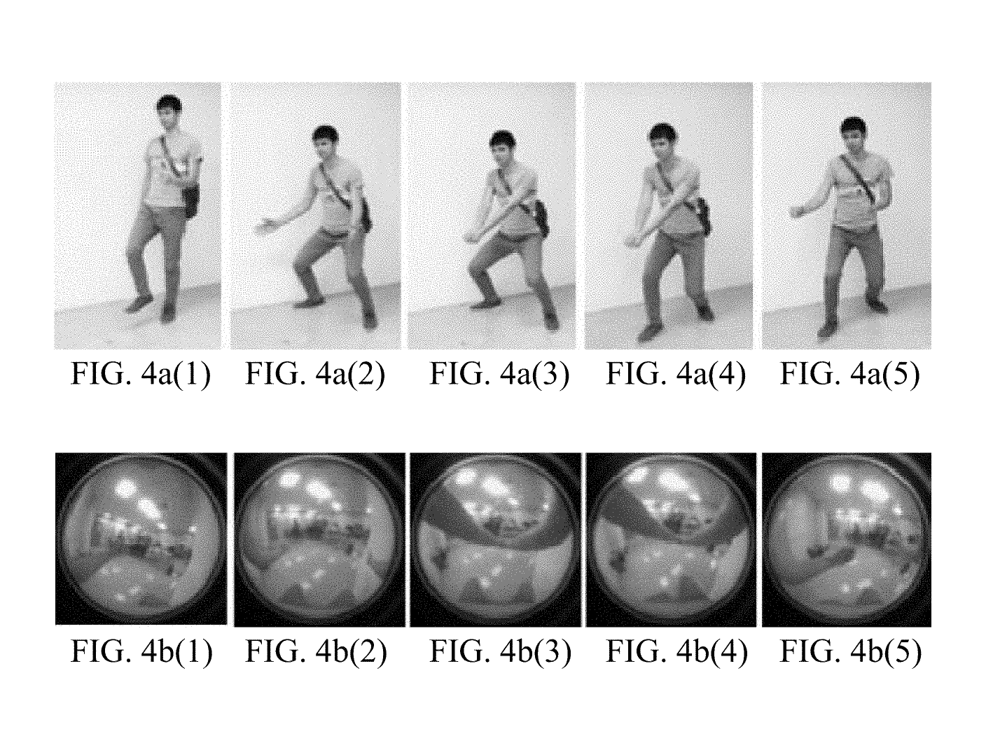

FIGS. 4a(1)-4a(5) and 4b(1)-4b(5) show that a user moves part of his body, such as arms or legs, and the single-piece wearable device worn on his center of body captures his limbs from a first-person perspective. Particularly as shown in FIGS. 4a(1) and 4b(1), when the user moves his left hand, the camera sees the left hand appearing at the left side of its angle-of-view from a first-person perspective. Also, in FIGS. 4a(2), 4b(2), 4a(3) and 4b(3), when the user squats or sits, the camera sees his legs appearing at the bottom side of its angle-of-view from a first-person perspective. Similarly, the actions of the limbs of the user shown in FIGS. 4a(4)-(5) are captured by the camera as shown in FIGS. 4b(4)-(5).

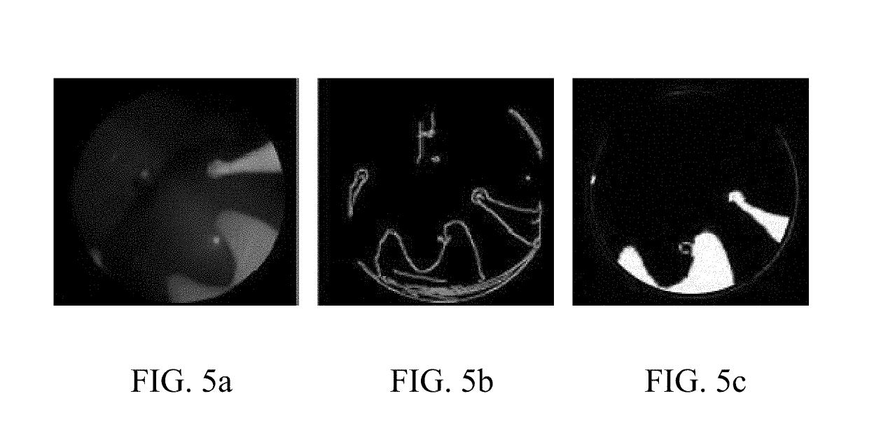

FIGS. 5a-5c illustrate a raw images being processed to extract foreground objects. As shown in FIG. 5a, a thresholding operation is applied to a raw image, to extract the foreground objects potentially containing the limbs, as shown in FIG. 5b. Subsequently, the overall foreground image is highlighted as shown in FIG. 5c. In an embodiment, incorporating depth information from an infra-red image or using a time-of-flight depth camera is helpful to distinguish the limbs from background objects.

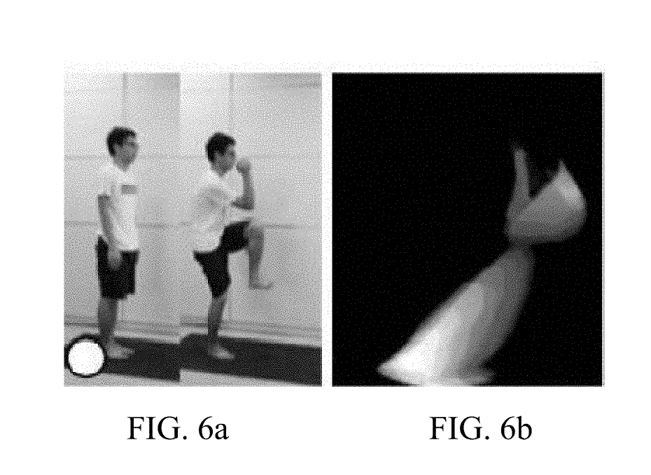

FIGS. 6a and 6b illustrate gesture image generation according to an embodiment of this application. As shown in FIG. 6a, the camera captures a sequence of raw images when the user moves from a normal standing position to a position of standing on one foot. The sequential raw images are converted into foreground images as shown in FIG. 5c, and then processed by means of intensity decay over time, and are merged into a gesture image shown FIG. 6b. In an embodiment, the gesture image is a motion history image (MHI) containing the spatial and temporal information of the motions of the user. As illustrated, the actions with a brighter color are performed earlier than that with a darker color. Therefore, the gesture image simultaneously records the spatial and temporal information of the motions of the user, and thus corresponds to a bodily gesture.

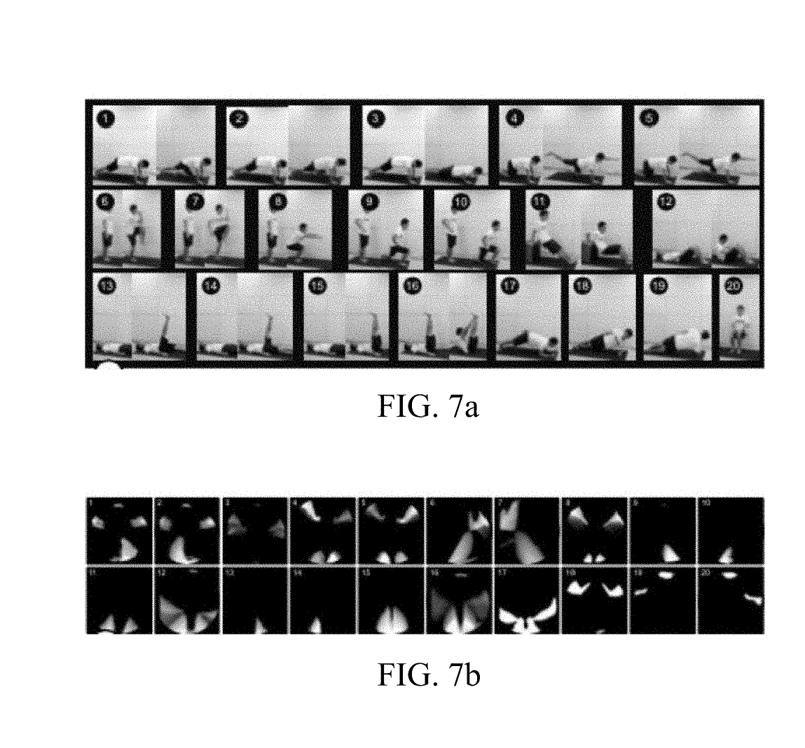

FIGS. 7a and 7b show twenty bodily gestures and twenty gesture images corresponding to the bodily gestures, respectively. In an embodiment, Random Decision Forest (RDF), artificial neural network, or other machine-learning approaches may be employed to build a recognition module which is capable of recognizing a bodily gesture according to the gesture images. For example, the recognition module can be built by establishing multiple decision trees with the gesture images of known gesture types provided as training samples in the case of RDF approach. Accordingly, it should be appreciated that the more the training images are utilized, the more accurate the recognition module can be. After the recognition module is properly trained, when the camera obtains a new sequence of raw images, the new sequence of raw images is processed by the processor to form a new gesture image. Subsequently, the new gesture image is passed to the recognition module to determine the corresponding gesture.

In an embodiment, the camera and the transmitter are integrated into a single-piece ring-style wearable device and worn on a user. The camera has an angle-of view of 185 degrees and is equipped with a fish-eye lens.

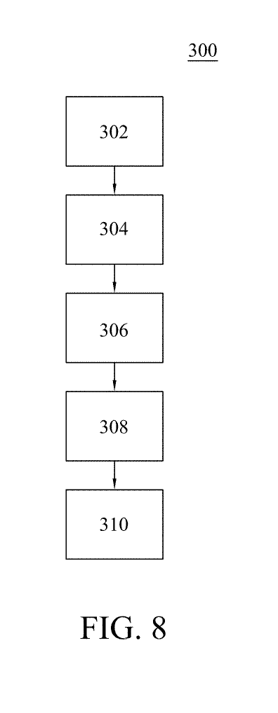

FIG. 8 is a flow chart of a method 300 for recognizing a hand gesture of a user according to an embodiment of the present disclosure.

In step 302, a camera having a wide angle-of-view is mounted on a finger of a user. In an embodiment, the camera has an angle-of-view of more than 180 degrees, such as 185 degrees.

In step 304, the camera captures a raw image of a hand of the user, where a portion of the hand, such as the fingers or a part of the palm, may be captured.

In step 306, the processor receives and processes the raw image. The processed raw image distinguishes the fingers and palm of the user from a background object by using the color information in which the fingers and palm of the user are considered as foreground objects.

In step 308, the processor generates a gesture image according to the processed raw image. Subsequently, the processor builds a recognition module given a plurality of gesture images. For example, the recognition module is trained by a plurality of gesture images with corresponding known hand gesture(s), such that the trained recognition module is capable of recognizing one or more hand gestures. In an embodiment, the recognition module is stored in a memory.

In step 310, when the user performs a hand gesture, the camera captures a new raw image of the hand of the user. The processor transforms the new raw image into a corresponding new gesture image and recognizes the hand gesture performed by the user through the recognition module according to the new gesture image.

In an embodiment, the memory further pre-stores at least one activation gesture image corresponding to at least one interaction mode. Accordingly, the processor is operated in the interaction mode when a new gesture image matches the activation gesture image.

In an embodiment, the camera and the transmitter are integrated into a single-piece wearable device, and can be worn as a ring. The camera has an angle-of view of 185 degrees and is equipped with a fish-eye lens.

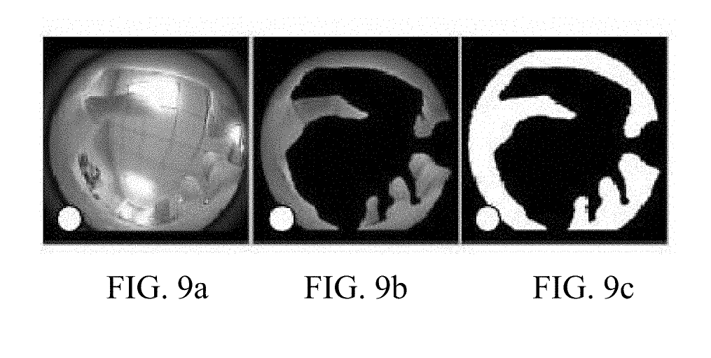

FIG. 9a shows a raw image of a hand obtained by the camera. FIG. 9b shows a processed image that the hand is recognized as the foreground object and the background object is removed. FIG. 9c shows a binary image with the hand marked as white and the background objects marked as black, and it can be processed by the recognition module to recognize the corresponding gesture. In an embodiment, the hand can be distinguished form the background objects by their skin color.

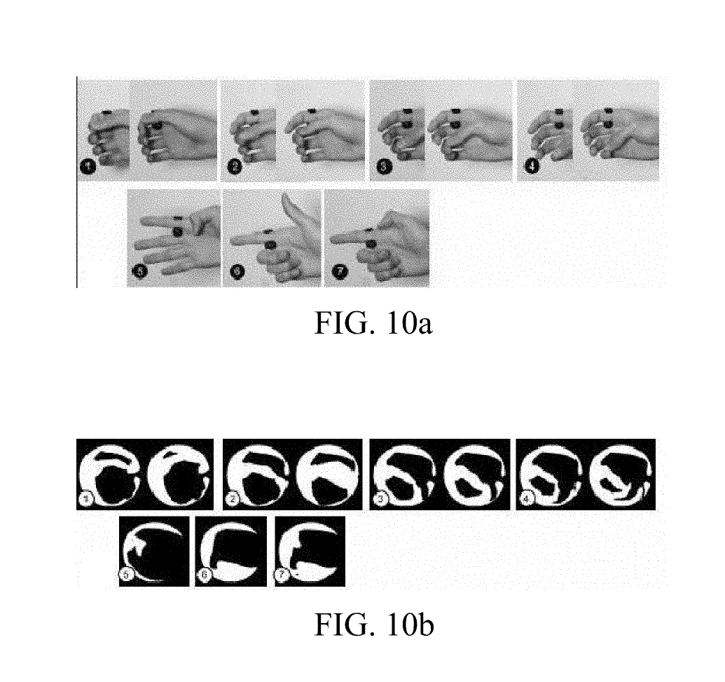

In an embodiment, the camera 11 can be positioned on a central portion of the hand of the user. In an embodiment, as shown in FIG. 10a, the transmitter 13 and the camera 11 can be integrated into a single-piece ring-style wearable device that can be worn on the index finger. In an embodiment, the camera 11 has an angle-of-view of about 185 degrees, such that the camera 11 can capture a raw image of the hand of the user including fingers and a part of the palm.

FIGS. 10a and 10b show seven hand gestures and seven gesture images corresponding to the seven hand gestures, respectively. In an embodiment, the recognition module can be built by Random Decision Forest (RDF), artificial neural network, or other machine-learning approaches. For example, the recognition module can be built by establishing multiple decision trees with the gesture images of known gesture types provided as training samples in the case of RDF approach. Accordingly, it should be appreciated that the more the gesture images are utilized, the more accurate the recognition module can be. In practice, when the camera obtains a new raw image, the new raw image is transformed into a new gesture image by the processor. Then, the hand gesture can be recognized by the recognition module according to the new gesture image.

In an embodiment, a plurality of activation gesture images are stored in the memory. As such, when a new gesture image representing a new hand gesture matches one of the activation gesture images, the processor enters the corresponding interaction mode. For example, the user may bend his thumb to enable a writing input mode, such that the user can use his index finger of one hand to write on the palm of another hand.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A gesture recognition system, comprising:
a camera configured to capture a user to obtain one or more raw images, wherein the camera is mounted on the user and has a wide angle-of-view;
a transmitter electrically connected to the camera to transmit the one or more raw images; and
a processor configured to receive and process the one or more raw images, transform the processed one or more raw images into a corresponding gesture image, and build a recognition module according to a plurality of gesture images, such that the processor recognizes a gesture of the user through the recognition module when one or more new raw images are captured by the camera.

2. The gesture recognition system according to claim 1, wherein the angle-of-view of the camera is more than 180 degrees.

3. The gesture recognition system according to claim 1, wherein the camera is mounted on a central portion of a body of the user, and is configured to capture a sequence of images of a limb of the user visible to the camera.

4. The gesture recognition system according to claim 1, wherein the camera is mounted on a finger of the user, and is configured to capture an image of a hand of the user.

5. The gesture recognition system according to claim 4, further comprising a memory storing at least one activation gesture image corresponding to at least one interaction mode.

6. The gesture recognition system according to claim 5, wherein the processor operates in the interaction mode when the new raw image corresponds to the activation gesture image.

7. The gesture recognition system according to claim 1, further comprising a memory storing the recognition module.

8. The gesture recognition system according to claim 1, wherein the camera emits light to the user, and obtains depth information related to the one or more raw images by receiving reflected light from the user.

9. The gesture recognition system according to claim 1, wherein the processor is configured to distinguish the user from a background object by using threshold, color or depth information.

10. A method for recognizing a gesture, comprising:
mounting a camera having a wide angle-of-view on a central portion of a body of a user;
capturing a sequence of raw images of a limb of the user visible by the camera;
receiving and processing the sequence of raw images;
transforming the sequence of raw images into a corresponding gesture image;
building a recognition module according to a plurality of gesture images; and
recognizing a bodily gesture of the user through the recognition module when a new sequence of raw images is captured by the camera.

11. The method according to claim 10, further comprising obtaining depth information related to the sequence of raw images.

12. The method according to claim 11, wherein processing the sequence of raw images comprises distinguishing the limb of the user from the background by using the depth information.

13. The method according to claim 10, wherein the processed sequence of raw images show spatial and temporal information of the gesture of the limb of the user.

14. The method according to claim 10, further comprising storing the recognition module in a memory.

15. A method for recognizing a gesture, comprising:
mounting a camera having a wide angle-of-view on a finger of a user;
capturing a raw image of a hand of the user by the camera;
receiving and processing the raw image;
transforming the raw image into a corresponding gesture image;
building a recognition module according to a plurality of gesture images; and
recognizing a hand gesture of the user through the recognition module when a new raw image is captured by the camera.

16. The method according to claim 15, wherein processing the raw image comprises distinguishing the hand of the user from a background object by their color.

17. The method according to claim 15, further comprising storing the recognition module in a memory.

18. The method according to claim 17, further comprising storing at least one activation gesture image into the memory.

19. The method according to claim 18, further comprising entering an interaction mode when the new raw image corresponds to the activation gesture image.
